(19) United States
(12) Patent Application Publication
(10) Pub. No.: US 2009/0272610 A1
(43) Pub. Date: Nov. 5, 2009

(54) BRAKE DISK AND MODULAR SYSTEM

(75) Inventors: OLIVER MOESSINGER, Forst (DE); BORIS SCHMIDT, Neuenbuerg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/428,508

(22) Filed: Apr. 23, 2009

(30) Foreign Application Priority Data
Apr. 30, 2008 (DE) 10 2008 022 553.3

(51) Int. Cl. F16D 65/12; B23P 19/00

(52) U.S. Cl. 188/264 AA; 29/700

(57) ABSTRACT

A built brake disk for a wheel brake of a vehicle, in particular an automobile, has two friction rings, between which a plurality of spacers are arranged to form cooling ducts of an internal ventilation of the brake disk, and further has a nave, which is arranged coaxially with the friction rings and is firmly connected to the friction rings and/or to a plurality of spacers.

### CROSS-REFERENCE TO RELATED APPLICATION

This application claims the priority, under 35 U.S.C. §119, of German application DE 10 2008 022 553.3, filed Apr. 30, 2008; the prior application is herewith incorporated by reference in its entirety.

### BACKGROUND OF THE INVENTION

### Field of the Invention

The present invention relates to a brake disk for a wheel brake of a vehicle, in particular an automobile. The invention also relates to a modular system for the manufacture of such brake disks.

Ceramic brake disks are known in modern sports vehicles. Outstanding features of these brake disks are their low weight, high wear resistance and high deceleration values. One disadvantage is the high manufacturing costs. These are moreover multiplied if the brake disk is to be provided with internal ventilation for cooling purposes.

### SUMMARY OF THE INVENTION

It is accordingly an object of the invention to provide a brake disk and a modular system that overcomes the above-mentioned disadvantages of the prior art devices of this general type, which will in particular permit a comparatively inexpensive manufacture of a ceramic brake disk.

With the foregoing and other objects in view there is provided, in accordance with the invention, a built brake disk for a wheel brake of a vehicle. The built brake disk contains two friction rings, a plurality of spacers disposed between the two friction rings and disposed to form cooling ducts defining an internal ventilation of the built brake disk, and a nave disposed coaxially with the friction rings and firmly connected to the friction rings and/or the plurality of spacers.

The invention is based on the general concept of assembling the brake disk from a plurality of components, that is to say from two friction rings, a plurality of spacers, which are arranged between the friction rings to form cooling ducts of an internal ventilation of the brake disk, and a nave, which is arranged coaxially with the friction rings and is firmly connected to the friction rings and/or to a plurality of spacers. The friction disks used to manufacture the built brake disk have a very simple geometric structure and can also be manufactured relatively inexpensively from ceramics, that is to say as ceramic friction rings. The ducting system, which is very costly to produce in conventional, internally ventilated ceramic brake disks, is achieved in the case of the built brake disk by spacers, which are suitably formed and arranged between the friction rings.

In this case the spacers can in principle be manufactured from the same material as the friction rings. They may preferably be formed of metal parts or ceramic composite materials. The spacers are especially inexpensive to manufacture as sintered parts.

According to one advantageous embodiment the spacers each have at least one passage, through which a fastener, such as a bolt or a rivet, for example, is fed, which serves to fasten the two friction rings together. This produces an easily achievable, very solid connection between the friction rings and the spacers.

The nave can be attached to the friction rings and/or to a plurality of spacers, for which purpose corresponding fasteners such as bolts, for example, can also be used. Alternatively the nave may be cast onto the friction rings and/or onto a plurality of spacers. By casting the nave onto the friction rings and/or onto the spacers it is also possible to achieve a close connection of great strength. If the naves are to be manufactured as castings anyway, the proposed design construction makes it possible to dispense with an additional manufacturing operation, since the naves can already be attached to the friction rings and/or to the spacers during casting, that is to say during their manufacture.

For manufacturing or building such built brake disks the invention furthermore proposes a modular system, which contains at least the friction rings, spacers and nave as components, each in a first configuration and in particular with at least one of these components also in at least one further configuration. This makes it possible to manufacture different types of brake disk by the modular system, so that a large number of identical parts can be used. For example, different numbers of spacers and/or differently shaped spacers may be used to produce different cooling duct geometries. Similarly brake disks of different thickness and/or different radii may be used to build up brake disks affording different performances. In addition the use of different naves can serve for adapting the brake disks to different attachment points on different vehicles.

It goes without saying that the aforementioned features and those yet to be explained below can be used not only in the particular combination specified but also in other combinations or individually without departing from the scope of the present invention.

Other features which are considered as characteristic for the invention are set forth in the appended claims.

Although the invention is illustrated and described herein as embodied in a brake disk and a modular system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a built brake disk according to the invention; and

FIG. 2 is an exploded, perspective view of the brake disk shown in FIG. 1.

### DETAILED DESCRIPTION OF THE INVENTION

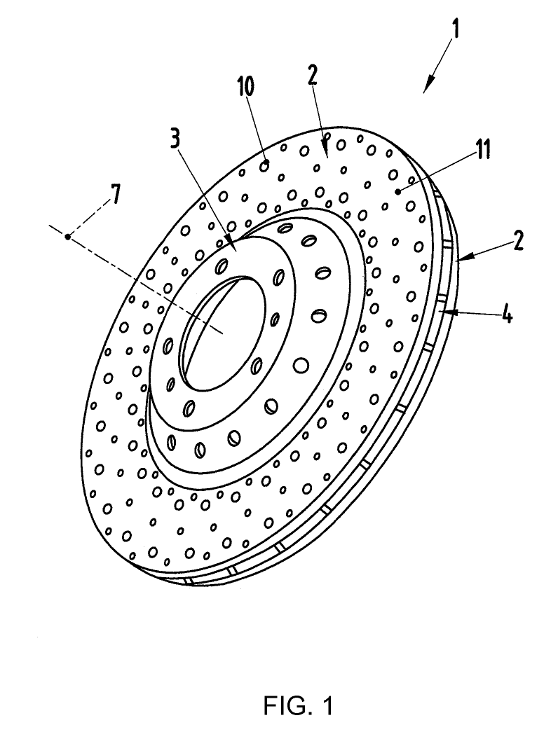

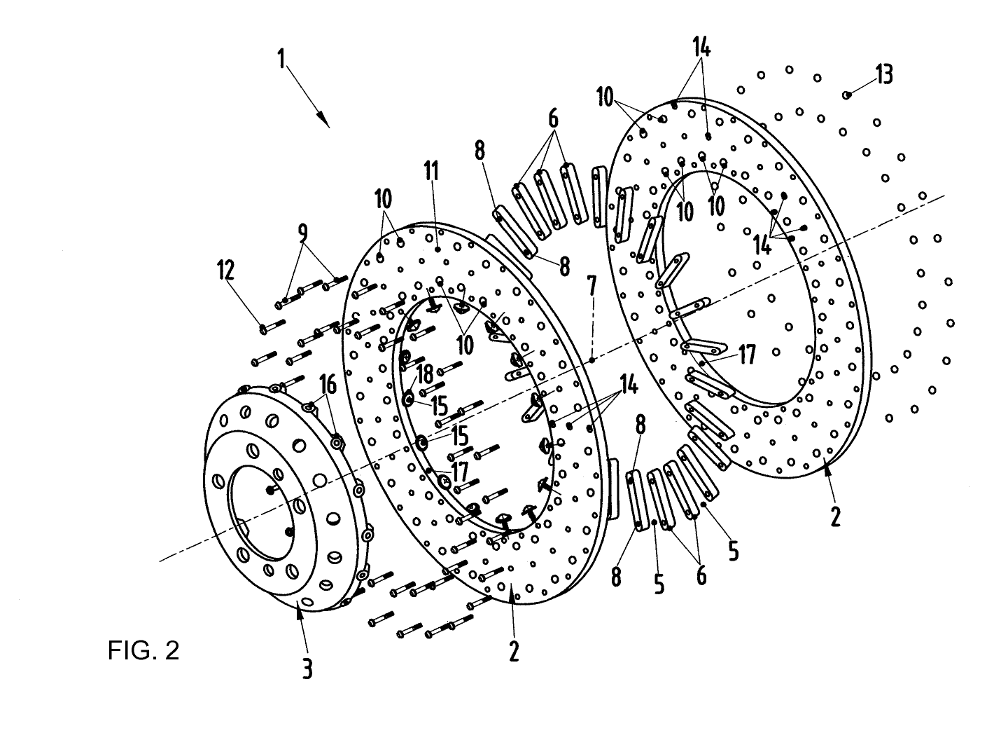

Referring now to the figures of the drawing in detail and first, particularly, to FIGS. 1 and 2 thereof, there is shown a built brake disk 1, which is intended for use in a wheel brake on a vehicle and has two friction rings 2 and a nave 3. The friction rings 2 are preferably composed of a ceramic material. They may equally be manufactured from grey cast iron, for example. It is also possible to manufacture one from ceramic and the other from metal. The ceramic friction rings 2 are composed of a ceramic material and in particular from a carbon-ceramic material. The friction rings are preferably manufactured from a ceramic composite material and in particular from a carbon fiber-reinforced silicon carbide. They afford an exceptionally low weight, high wear resistance and high deceleration performance. The nave 3 is suitably a metal component, which may be manufactured by deep-drawing or by casting.

The brake disk 1 also has internal ventilation 4, which is achieved by a plurality of cooling ducts 5 formed axially between the two friction rings 2. In order to form these cooling ducts 5 between the friction rings 2, the brake disk 1 according to FIG. 2 has a plurality of spacers 6, which are arranged axially between the friction rings 2. The design shape and arrangement of the spacers 6 is here purposely selected so as to form the cooling ducts 5 defining the internal ventilation 4.

The nave 3 is arranged coaxially with the friction rings 2. The nave 3 is furthermore firmly connected to the friction rings 2 and/or to a plurality of spacers 6.

In the example shown in FIG. 2 the spacers 6 are produced by rectilinear webs, which are arranged radially in a star-shaped pattern about a longitudinal center axis 7 of the brake disk 1. The cooling ducts 5 are in this case formed between each two circumferentially adjacent spacers 6, for which purpose the spacers 6 are arranged separated from one another in the circumferential direction. In this configuration the cooling ducts 5 are comparatively short and likewise oriented radially. In another embodiment the spacers 6 may be curved, for example, making it possible to form corresponding curved cooling ducts 5.

The spacers 6 each have at least one passage 8. In the example shown each spacer 6 has two such passages 8. Pin-shaped fasteners 9, serving to fasten the two friction rings 2 together, are fed through these passages 8. The fasteners 9 are bolts or rivets, for example. Where a softer material, such as grey cast iron, for example, is used for the friction rings 2 or for one of the friction rings 2, particularly in combination with a friction ring 2 of a harder material, such as ceramic, bolts are preferred as fasteners 9, in order to afford a facility for easy, inexpensive repair through replacement of the wearing part.

In order to be able to fix the two friction rings 2 together by the fasteners 9, the friction rings 2 are also equipped with passages 10, through which the fasteners 9 are fed. On the outsides 11 of the friction rings 2 remote from the internal ventilation 4 the passages 10 in the friction rings 2 suitably have an enlarged cross section, which allows for the countersunk accommodation of an expanded end 12 of the respective fastener 9 or a mating element 13 wider than the fastener 9. Depending on the fastener 9, the mating element 13 may be a washer and/or a nut, for example.

The friction rings 2 furthermore contain a plurality of ventilation openings 14, which communicate with the cooling ducts 5.

In the example shown the nave 3 is attached to the friction rings 2 by suitable fasteners 15. The fasteners 15 are bolts, for example, which are screwed into threaded openings 16. The threaded openings 16 are here formed on the nave 3. The bolts 15 are supported on a radially inner edge 17 of the friction rings 2, for example by way of washers 18.

It is likewise in principle possible to cast the nave 3 onto the friction rings 2 and additionally or alternatively onto a plurality of spacers 6. Given a corresponding design shape of the friction rings 2 and/or of the spacers 6, it is possible through the casting process to achieve a positive interlock (form shape locking where the shape of the items forms the interlocking), which lends sufficient strength to the connection between the nave 3 and the friction rings 2 and spacers 6.

To attach the nave 3 it is also possible to dimension some of the spacers 6 so that they protrude radially inwards beyond the inner edge 17 of the friction rings 2. These inwardly protruding end sections of the respective spacers 6 then allow the nave 3 to be connected, for example through attachment by fasteners or by casting on.

In this case all the spacers 6 can in principle protrude radially inwards beyond the inner edge 17 of the friction rings 2. Alternatively, however, it may be sufficient to configure individual spacers 6, uniformly distributed in a circumferential direction, longer than the other spacers 6, so that these protrude radially inwards beyond the inner edge 17 of the friction rings 2.

The embodiment shown here, in which both the spacers 6 and the friction rings 2 in each case form inherently identical parts, is particularly advantageous. The use of identical parts makes it possible to reduce the unit price of the parts, which reduces the manufacturing costs.

The built brake disk 1 presented here can be suitably manufactured and built up from a modular system. Such a modular system contains the friction rings 2 and the spacers 6, together with the nave 3, each in a first configuration. This alone makes it possible to manufacture different brake disks 1, for example through the use of a different number of spacers 6. The modular system is particularly advantageous, however, if at least one of the components, the spacers 6, the friction rings 2 and the nave 3 is also present in at least one further configuration. For example, a plurality of different naves 3 may be provided, which allow the brake disk 3 to be attached to different wheel brakes and/or to different vehicles. In addition, different friction rings 2 may be provided, which differ from one another in their radii, for example, and/or in their thicknesses and/or in their materials (metal or ceramic). In addition different spacers 6 may also be provided, which in particular have different lengths and/or different thicknesses and/or different geometries, in order to provide different degrees of internal ventilation 4.

By such a modular system it is possible, using a plurality of identical parts, to assemble different brake disks 1, which reduces the manufacturing costs of the individual brake disks 1.

1. A built brake disk for a wheel brake of a vehicle, the built brake disk comprising:
two friction rings;
a plurality of spacers disposed between said two friction rings and disposed to form cooling ducts defining an internal ventilation of the built brake disk; and
a nave disposed coaxially with said friction rings and firmly connected to at least one of said friction rings and said plurality of spacers.

2. The brake disk according to claim 1,
further comprising fasteners; and
wherein said spacers each have at least one passage formed therein, through said passage one of said fasteners is fed, said fasteners fastening said two friction rings together.

3. The brake disk according to claim 1, wherein said nave is one of attached and cast onto at least one of said friction rings and said plurality of spacers.

4. The brake disk according to claim 1, wherein said spacers are disposed in a star-shaped pattern.

5. The brake disk according to claim 1, wherein at least some of said spacers protrude radially inwards beyond an inner edge of said friction rings, and are there connected to said nave.

6. The brake disk according to claim 1, wherein said spacers are separated from one another in a circumferential direction, for forming said cooling ducts of said internal ventilation between said spacers.

7. The brake disk according to claim 1, wherein at least one of said spacers and said friction rings are formed as identical parts.

8. The brake disk according to claim 1, wherein at least one of said friction rings is a ceramic friction ring.

9. The brake disk according to claim 1, wherein the brake disk is for an automobile.

10. A modular system for building brake disks, the modular system comprising:
friction rings;
spacers; and
naves, said friction rings, said spacers and said naves defining a first configuration;
said plurality of spacers can be disposed between said two friction rings and disposed to form cooling ducts defining an internal ventilation of a brake disk, said nave to be disposed coaxially with said friction rings and firmly connected to at least one of said friction rings and said plurality of spacers.

11. The modular system according to claim 10, wherein at least one of said friction rings, said spacers and said naves is also present in at least one further configuration.
